(19) United States
(12) Patent Application Publication
(10) Pub. No.: US 2025/0088890 A1
(43) Pub. Date: Mar. 13, 2025

(54) METHOD AND SYSTEM FOR SENSING-ASSISTED BEAM REFINEMENT AND PREDICTION FOR COMMUNICATIONS

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US); Jung Hyun BAE, San Diego, CA (US)

(21) Appl. No.: 18/821,334

(22) Filed: Aug. 30, 2024

Related U.S. Application Data
(60) Provisional application No. 63/581,146, filed on Sep. 7, 2023.

(51) Int. Cl. H04W 24/10; H04L 41/147

(52) U.S. Cl. CPC H04W 24/10; H04L 41/147

(57) ABSTRACT

Methods and devices of a wireless system are provided. A user equipment (UE) of the wireless system receives configuration information from a base station (BS). The UE transmits repetitions of joint communication and sensing (JCS)-reference signals (RSs) on a first set of beams based on the configuration information. The UE determines a beam blockage prediction measurement for communication of a second set of beams received corresponding to the first set of beams. The UE transmits the beam blockage measurement to the BS.

### CROSS-REFERENCE TO RELATED APPLICATION

This application claims the priority benefit under 35 U.S.C. § 119 (e) of U.S. Provisional Application No. 63/581,146, filed on Sep. 7, 2023, the disclosure of which is incorporated by reference in its entirety as if fully set forth herein.

### TECHNICAL FIELD

The disclosure generally relates to wireless systems. More particularly, the subject matter disclosed herein relates to improvements to integrated sensing and communication (ISAC) in wireless systems.

### SUMMARY

In a wireless system with ISAC, sensing and communication may share the same frequency band and hardware. As wireless technologies, such as, for example, massive multiple input-multiple output (MIMO), evolve with more antenna elements and a wider bandwidth in higher frequency bands (e.g., millimeter-wave (mmWave) bands), they become more reliant on increasingly specific and accurate assistance information (e.g., distance (range), angle, instantaneous velocity, and area of objects).

To solve this problem, wireless sensing technologies aim to acquire information about a remote object without physical contact. The sensing data of the object and its surroundings may then be utilized for analysis so that meaningful information about the object and its characteristics may be obtained with high resolution and reliable accuracy.

Leveraging the strengths of wireless sensing technologies may be advantageous for the development of future wireless communication technologies. Accordingly, the integration of sensing and communication in 5th generation (5G)-Advanced and 6th generation (6G) wireless systems is expected to be beneficial.

Wireless sensing may assist with a beam management procedure. However, a mmWave system may be vulnerable to link blockage due to its relatively short wavelength and high directional beamforming capabilities. mmWave links may be easily disrupted by passing individuals or vehicles.

To solve this problem, a small backup set of beam links may be generated during initial beam training. When the current link is blocked, the base station (BS) (or mobile station (MS) or user equipment (UE)) may quickly switch to one of the backup beam pairs to maintain connectivity. The backup set may include beam pairs having a highest reference signal receiving power (RSRP).

One issue with the above approach is that beam training procedures have not considered initially selecting a beam based on existing link blockage statistics, which may lead to beam failure or even radio link failure.

To overcome these issues, systems and methods are described herein in which a sensing signal may be used to predict beam blockage in future time instances, which can proactively avoid beam failure. Thus, signaling may enable sensing-assisted beam blockage prediction.

In an embodiment, a method is provided in which a UE receives configuration information from a BS. The UE transmits repetitions of joint communication and sensing (JCS)-reference signals (RSs) on a first set of beams based on the configuration information. The UE determines a beam blockage prediction measurement for communication of a second set of beams received corresponding to the first set of beams. The UE transmits the beam blockage measurement to the BS.

In an embodiment, a wireless system is provided that includes a UE configured to receive configuration information from a BS, transmit repetitions of JCS-RSs on a first set of beams based on the configuration information, determine a beam blockage prediction measurement for communication of a second set of beams received corresponding to the first set of beams, and transmit the beam blockage measurement to the BS. The wireless system also includes the BS configured to transmit the configuration information to the UE and receive the beam blockage measurement from the UE.

In an embodiment, a UE of a wireless system is provided. The UE includes a processor and a non-transitory computer readable storage medium storing instructions. When executed, the instructions cause the processor to receive configuration information from a BS, transmit repetitions of JCS-RSs on a first set of beams based on the configuration information, determine a beam blockage prediction measurement for communication of a second set of beams received corresponding to the first set of beams, and transmit the beam blockage measurement to the BS.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating sensing modes of a wireless communication system;

FIG. 2 is a diagram illustrating an orthogonal frequency division multiplexing (OFDM)-based sensing frame;

FIG. 3 is a diagram illustrating beam management configuration adaptation based on beam blockage rate reporting, according to an embodiment;

FIG. 4 is a diagram illustrating UE detection of obstacles by radar sensing in a line of sight (LOS) portion of a link from the UE to the BS, according to an embodiment;

FIG. 5 is a diagram illustrating UE-based radar sensing assisted DL beam blockage prediction, according to an embodiment;

FIG. 6 is a diagram illustrating machine learning (ML)-based sensing assisted beam prediction, according to an embodiment;

FIG. 7 is a flowchart illustrating a method for sensing-assisted beamforming, according to an embodiment; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purposes only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Wide bandwidths and large antenna arrays may be considered symbols of high-resolution radar systems and modern communication systems. Applicable frequencies have increased in successive generations of communication systems and many key radar bands for high resolution sensing are merging with communication bands. For example, popular radar bands including K (18 gigahertz (GHz)-26.5 GHz) and Ka (26.5 GHz-40 GHz) are close to popular mmWave communication bands. Furthermore, the bandwidth of modern communication systems is fairly large, thereby creating opportunities for ISAC.

Radar technology and wireless telecommunications have coexisted for some time, but efforts have generally concentrated on interference management that enables the two technologies to operate as smoothly as possible without disturbing one another. These efforts have increased infrastructure costs and resulted in spectrum usage inefficiencies.

ISAC refers to the introduction of sensing capability to wireless communication networks. An objective of ISAC is to share the spectrum more efficiently and reuse the existing wireless network infrastructure for sensing. Sensing may refer to “radar-like” functionality (i.e., the ability to detect the presence, movement, and other characteristics of objects under the coverage of the wireless network). However, sensing may also refer to other types of sensing, such as, for example, detection of general characteristics of the environment, local weather conditions, etc.

Compared to the deployment of a separate network providing a sensing functionality, ISAC is beneficial in that the sensing capability may be introduced on large scale at a relatively low incremental cost by piggybacking on infra-structure that is already deployed for communication purposes. A massive communication infrastructure already exists, and an even more dense deployment may be available in future generations of wireless communication, which would allow for enhanced sensing capabilities. Accordingly, it may be possible to enable mono-static radar applications, in which the transmission of a radar signal and the reception of a reflected signal are handled by the same node, as well as various multi-static setups, in which transmission and reception are handled by different collaborating nodes.

If implemented properly, the integration of sensing into a communication network provides for better spectrum utilization when compared to assigning separate spectrum chunks for the two applications.

ISAC has begun to emerge as part of standardization efforts. For example, one such standard aims to use sensing to benefit end user applications (e.g., home security, entertainment, energy management home elderly care, and assisted living). There has also been an increased effort to introduce ISAC in a beyond 5G standard for applications such as traffic monitoring and safety, presence detection, localization and mapping, etc.

Sensing and communication traditionally address completely different sets of use cases and requirements. In its simplest form, sensing uses a known signal that is sent in a particular direction. By analyzing a reflected signal, various parameters such as channel response, target-presence, and target properties (e.g., position, shape, size, velocity, etc.) may be estimated. In contrast, communication key performance indicators include data-rate, latency and reliability. This leads to sensing signal characteristics (e.g., bandwidth, time duration, periodicity, power, etc.) to be different than those used for communication purposes.

There are multiple market segments and verticals in which 5G-Advanced-based sensing services may be beneficial for intelligent transportation, aviation, enterprise, smart city, smart home, smart factories, consumer applications, and public sector. A sensing wireless system, that relies on the same 5G new radio (NR) wireless communication system and infrastructure, offers sensing information that may be utilized to assist wireless communication functionalities, such as, for example, radio resource management, interference mitigation, beam management, mobility, etc. Sensing services and sensing-assisted communications may be more efficient when wireless sensing and communication are integrated in the same wireless channel or environment.

Four use cases that may benefit from ISAC include the perception of blind spots in road traffic areas, the perception of road dynamic information, contactless respiration monitoring, and gesture recognition.

With respect to the perception of blind spots in road traffic areas, a blind spot of a car refers to an area where a driver's line of sight is blocked by obstacles or the car itself and cannot be directly observed by the driver. Sub-use cases may relate to heavy vehicles having large blind spots that cause the most traffic accidents.

With respect to the perception of road dynamic information, this use case may be classified into traffic jam detection and traffic safety risk detection. Severe traffic congestion directly reduces travel efficiency, impacts people's lives, and limits manufactory production, while indirectly increasing air pollution and affecting people's health. Dangerous driving behaviors may be induced by speeding, sharp turns, sudden acceleration, and sudden braking. Current detection that focuses on the acquisition of road dynamic information generally relates to cameras and speed-measuring radars having a limited deployment scope.

With respect to contactless respiration monitoring, respiratory diseases suffered by people worldwide incur a large global health burden, particularly for vulnerable infants and young children. A human's sleep situation may be monitored with 3GPP-based wireless signals.

With respect to gesture recognition, there is flexibility in expressing meanings from portions of the human body, such as a head, a hand, a leg, and a combination of human body parts. Two types of schemes for gesture recognition include device-based and device-free, which correspond to wearable devices and non-wearable devices, respectively. Common sensors for device-based solutions include a camera, a depth camera, a glove, and a wristband, while sensors for device-free solution include radar.

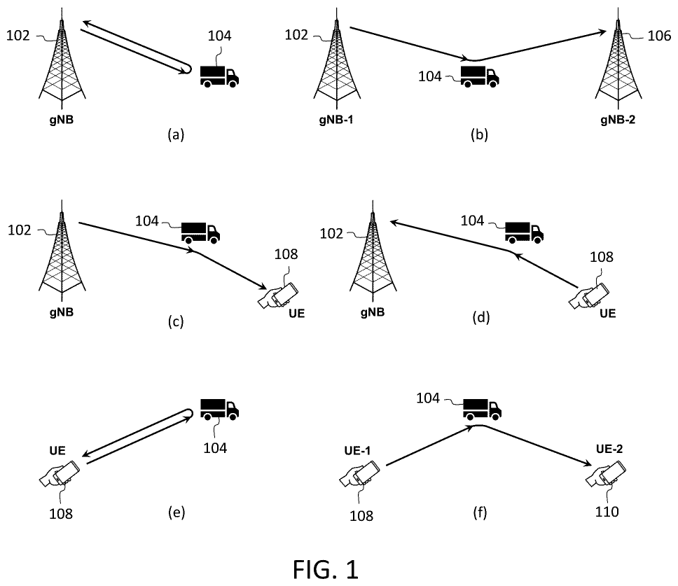

FIG. 1 is a diagram illustrating six sensing modes. A first mode (a) is gNode B (gNB)-based mono-static sensing in which a sensing signal is transmitted from a first gNB 102 and a signal reflected from an object 104 is received by the first gNB 102. A second mode (b) is gNB1-to-gNB2 based bi-static sensing in which a sensing signal is transmitted from the first gNB 102 and a signal reflected from the object 104 is received by a second gNB 106. A third mode (c) is gNB-to-UE-based bi-static sensing in which a sensing signal is transmitted from the first gNB 102 and a signal reflected from the object 104 is received by a first UE 108. A fourth mode (d) is UE-to-gNB-based bi-static sensing in which a sensing signal is transmitted from the first UE 108 and a reflected signal from the object 104 is received by the first gNB 102. A fifth mode (e) is UE-based mono-static sensing in which a sensing signal is transmitted from the first UE 108 and a reflected signal from the object 104 is received by the first UE 108. A sixth mode (f) is UE1-to-UE2-based bi-static sensing in which a sensing signal is transmitted from the first UE 108 and a reflected signal from the object 104 is received by a second UE 110. Several sensing modes may also be used together.

In a typical radar-like scenario, there are requirements for certain parameters. These parameters include range resolution (Rr), which is a minimum distance between two objects that is distinguishable by a radar, unambiguous range (Ru), which is a maximum range that an object can be unambiguously detected, velocity resolution (vr), which is a minimum change in speed that can be measured by the radar, and unambiguous velocity (vu), which is a maximum range of speed (vmax-vmin) that can be measured by the radar. Based on these parameters, there are requirements on the duration, bandwidth, and periodicity of the sensing signal.

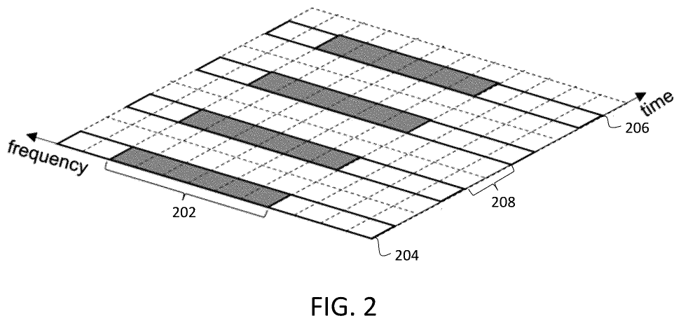

FIG. 2 is a diagram illustrating an OFDM-based sensing frame. A bandwidth (BW) 202 of a sensing signal is shown along a frequency at a given time. The sensing frame begins at an initial time Tᵢₙₜ 204 and ends at a final time T_{f} 206 of the sensing frame duration, with a gap Tᵣ 208 between sensing signals in the sensing frame.

Table 1 shows the relationship between sensing signal parameters and sensing requirements.

TABLE 1

| | |
|---|---|
| Minimum bandwidth | BWₘᵢₙ = c/2Rᵣ |
| Minimum gap between sensing signals | T_{r min} = 2Rᵤ/c |
| Maximum gap between sensing signals | T_{r max} = c/4f_{c}vᵤ |
| Minimum sensing frame duration | T_{f min} = c/2f_{c}vᵣ |

Radar sensing may assist with a beam management procedure. For example, a mmWave system may be vulnerable to link blockage primarily due to its relatively short wavelength and high directional beamforming capabilities. When an obstruction exists in a line-of-sight (LOS) path, attenuation may increase by over 20 decibels (dB). Consequently, mmWave links may be disrupted by passing individuals or vehicles. To mitigate this, the BS or MS may quickly switch to a backup set of beam links generated during initial beam training. For example, for a BS's transmission (Tx) beam selection, a UE may choose a beam based on the signal quality of downlink (DL) transmissions. However, this may overlook blockage statistics associated with the selected beam, and it may be possible for the UE to receive a beam from a different transmission and reception point (TRP) with a lower blockage probability and similar or worse DL channel quality. This alternative beam may be a better candidate due to its low blockage probability, which is less likely to trigger beam failure or radio link recovery (RLR). Therefore, methods that consider estimated blockage statistics may be utilized for beam selection.

A blockage-detection-based proactive beam refinement procedure may proactively minimize beam failure events. A UE may be configured to transmit reference signals (RSs) at specific times for sensing purposes, such as for detecting objects in close proximity. These RSs may be used for joint communication and sensing (JCS) or may be dedicated solely to sensing. The RS configuration may include parameters such as, for example, periodicity, offset, repetition, starting symbol, symbol offset, starting physical resource block (PRB), number of PRBs, PRB offset, resource element (RE) offset, RE density, number of ports, and power control parameters. The UE may receive the RS configuration through radio resource control (RRC) signaling, either in an RRC configuration message or as part of a separate activation or deactivation message transmitted over a downlink control channel. The downlink control channel may be scrambled using the UE's radio network temporary identifier (RNTI), such as the cell-RNTI (C-RNTI). Alternatively, the RS configuration and activation may be simultaneously received in downlink control information (DCI) scrambled with the UE's RNTI. In some cases, a new identity (e.g., JCS RS-RNTI) may be allocated by the network (e.g., gNB, eNode B (eNB), or BS) for de-scrambling the DCI containing the RS configuration. Additionally, other uplink RSs configured for the UE, such as, for example, sounding reference signals (SRSs) and demodulation reference signals (DMRSs), may be utilized for sensing purposes.

In order to perform sensing, the UE may transmit RSs on specific resources that have been configured, and in a pre-defined set of beam directions configured by the network or determined by the UE and/or assist information provided by neighboring UEs. The beam direction may be defined as the transmit spatial filter, which quasi co-location-ed (QCLed) type D with a specific CSI-RS or SSB signal transmitted by the gNB or another UE. Following the transmission of RSs, the UE may be able to monitor and conduct measurements on backscatter signals. For example, the UE may measure the received power and phase of the backscatter signal, estimate the channel impulse response and relevant parameters (e.g., round-trip time, delay spread, pathloss), and perform cross-correlation between the received backscatter and the sequence used for RS transmission. The UE may be configured to perform measurements with different levels of granularity in the frequency domain. This may be performed on a wideband basis or sub-band basis. In the case of sub-band measurements, the UE receives specific sub-band configuration details, such as the number of sub-bands, the number of physical resource blocks (PRBs) per sub-band, and the starting PRB for each sub-band. In scenarios such as beam-based systems, in some cases, the UE may be capable of monitoring and measuring the backscatter on receive beams corresponding to the transmit beams used for RS transmission.

In determining a beam blockage rate, based on the backscatter measurements, the UE may be configured to report various aspects such as, for example, the number of blocked beams, the beam blockage rate, the received signal strength on the backscatter signal for each beam, and wideband- or sub-band-based measurements. The reporting configuration may be set to operate periodically, semi-persistently, or a-periodically. The time-frequency resources necessary for reporting may be configured over an uplink control channel, such as a physical uplink control channel (PUCCH) or a physical uplink shared channel (PUSCH). The parameters of the beam blockage reporting configuration may consist of time-frequency resources (utilizing PUCCH or PUSCH), a reporting quantity (e.g., number of blocked beams, beam blockage rate), one or more parameters associated with blockage detection (e.g., detection threshold), and/or the number of measurement cycles (N) used to derive average statistics. The reporting configuration may be communicated to the UE through an RRC configuration or system information. Alternatively, the reporting configuration may be activated or deactivated by sending an activation or deactivation command via the downlink control channel. The command may be signaled over the downlink channel using DCI scrambled with an identifier, such as, for example, the RNTI of the UE. By monitoring and measuring the backscatter of the transmitted reference signal sequences over the receive beam, the UE may determine the blockage in the direction of that beam. A detection threshold may be employed to identify blockage. For example, if the received backscatter power over a receive beam surpasses the detection threshold, the UE may identify it as a blocked receive beam; otherwise, it may be considered an unblocked beam. The detection threshold may be communicated to the UE as part of the beam blockage reporting configuration.

The UE performs blockage detection for each of the beams used for transmitting RSs in order to sense its environment. By detecting blockages, the UE may compute the number of blocked beams out of the total number of beams it measures. In cases where the UE is configured to report the beam blockage rate, it may utilize a measurement of the number of blocked beams observed over multiple measurement periods, denoted as N. This configuration parameter may be set as part of the beam blockage reporting mechanism. To determine the beam blockage rate, the UE may rely on the latest measurement period (e.g., Kth period) and a weighting factor W (i.e., by using an exponential moving average method). This weighting factor, which is communicated to the UE, may assist in quantifying the importance or significance of the blocked beams during the reporting process. Alternatively, the UE may be configured to report beam blockage statistics for specific beams, with reference to the serving beam. For example, the UE may report the beam blockage rate for a group of beams covering a specific angular range (theta) starting from the right side (clockwise) of the serving receiver (Rx) beam. These reports may also include additional information including beam indications or identifications, such as, for example, beam number, direction, theta, and associated synchronization signal block (SSB) ID, SRS ID, or CSI-RS ID. In another example, the UE may prepare a report for each configured wideband or sub-band, containing the necessary beam blockage statistics such as, for example, the number of blocked beams, blockage rate, and the received signal strength on the backscatter signal for each beam. These reports may then be sent to the network (e.g., the gNB or BS) on the specified resources for analysis and decision-making.

Upon receiving one or more beam blockage reports from a UE, the network may utilize the blockage statistics to determine various parameters specific to the UE's operation. For example, based on the received reports, the network may decide the number of CSI-RS resources required for UE receive beam sweeping, instead of requiring the UE Rx sweeping in all possible beams within the angular domain of a broad beam. This may entail configuring a suitable number of CSI-RS resources within one or more CSI-RS resource sets, considering factors such as repetition. Similarly, the network may employ beam blockage statistics along with the beam indications provided by the UE to derive the mobility pattern of obstacles or the UE itself. The gNB may avoid future beam failure using future beam blockage reported from the UE and may proactively re-select the DL beam for DL transmission.

The sensing signal transmission may be the byproduct of a set of sensing applications, which are running in parallel with communication. The sensing signal may be used for reducing beam sweeping overhead. Specifically, the sensing signal may not be transmitted only for the purpose of assisting communication, which reduces unnecessary overhead.

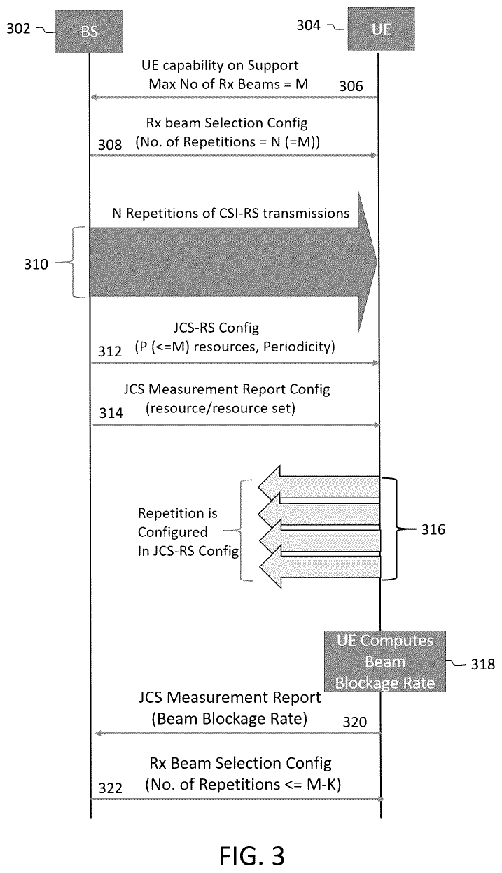

FIG. 3 is a diagram illustrating beam management configuration adaptation based on beam blockage rate reporting, according to an embodiment. A UE 304 may convey its capabilities, including a maximum number of Rx beams that it can support (M), to a BS 302, at 306. The BS 302 may configure the UE 304 with a specific number of CSI-RS transmission repetitions for Rx beam selection as the Rx beam refinement procedure, at 308. This number of CSI-RS repetitions (N) may be set to be less than or equal to the maximum number of Rx beams supported (M) by the UE 304. The BS 302 may employ the same Tx antenna configuration for all N repetitions, while the UE 304 may switch the Rx antenna configuration for each repetition, at 310.

In order to determine obstacles in different directions, the BS 302 may configure the UE 304 with a set of P resources dedicated to JCS-RS transmissions and measurements, at 312, where the value of P should not exceed the maximum number of Rx beams supported (M) by the UE 304. The BS 302 may configure the UE 304 with specific resources, or a resource set allocated for reporting JCS measurements, at 314. As illustrated in FIG. 3, the UE 304 may utilize the configured resources to transmit JCS-RSs and may measure the backscatter power by employing the corresponding Rx beams, at 316. If multiple resources are allocated within a resource set, the UE 304 may employ different beams for transmitting repetitions and use corresponding Rx beams for reception. The UE 304 calculates a beam blockage rate based on the measured backscatter power, at 318. Subsequently, using the allocated resources for JCS measurement reporting, the UE 304 may transmit a report that includes the beam blockage rate, at 320. Following this transmission, the UE 304 may receive, from the BS 302, a new Rx beam selection configuration, at 322, which may involve a different number of resources for performing Rx beam refinement. The number of resources provided in this new configuration is indicated as less than or equal to M-K, where M is the original configured number of resources for Rx beam sweeping and K is the number of beams that have blockage detected by UE radar sensing.

In addition to the UE Rx beam refinement enhancement, the UE-based radar sensing may also assist the DL beam switching procedure during UE mobility, especially in a non-LOS (N-LOS) condition. The UE-based radar sensing detection and prediction may be needed when gNB-based radar sensing is not sufficient. This may occur when there is a N-LOS link between the UE and the BS and radar sensing performed at the BS is limited by obstacles or obstructions in the LOS portion of the link from BS to the UE. The radar sensing of the BS may not be able to detect and predict the obstacles or obstructions in the N-LOS portion of the link from the BS to the UE, whereas the UE may be able to detect the obstacles or obstructions by radar sensing in the LOS portion of the link from the UE to the BS.

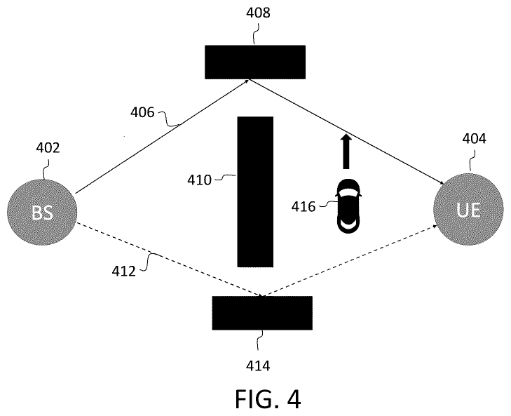

FIG. 4 is a diagram illustrating UE detection of obstacles by radar sensing in the LOS portion of a link from the UE to the BS, according to an embodiment. Between a BS 402 and a UE 404, an existing beam 406 is reflected off a first object 408 above a second object 410, such that the existing beam 406 includes an LOS portion and an N-LOS portion for both BS 402 and the UE 404. A back-up beam 412, between the BS 402 and the UE 404, is reflected off a third object 414 below the second object 410. Based on radar sensing, the UE 404 may predict that the existing beam 406 will be blocked by movement of a car 416. The UE 404 may indicate this blockage to the BS 402 in advance to proactively avoid beam failure, thereby providing a more reliable connection with minimized interruption of the communication link.

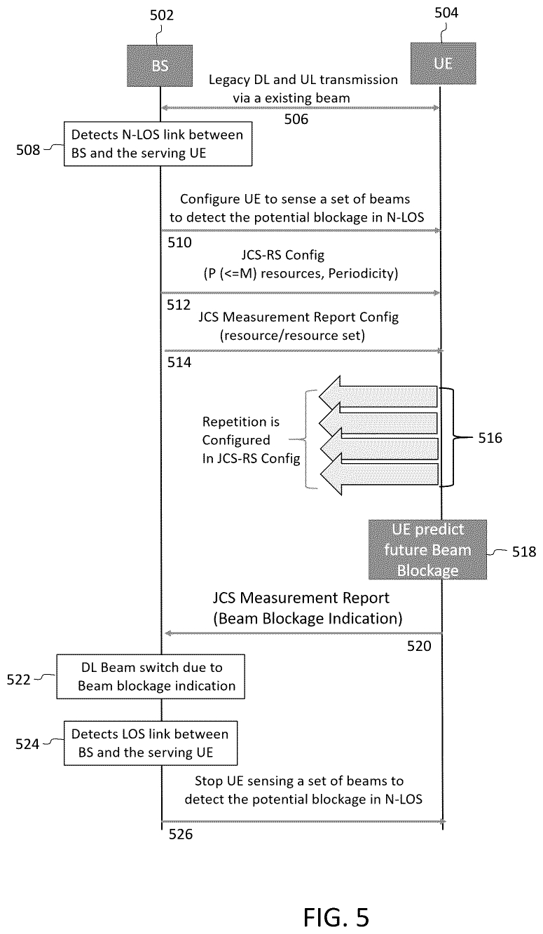

FIG. 5 is a diagram illustrating UE-based radar sensing assisted DL beam blockage prediction, according to an embodiment. A BS 502 may be in communication with a UE 504 via an existing link or beam, at 506, which may reflect on an object before reception of the transmission. The BS 502 may detect a N-LOS link condition between the BS 502 and the UE 504, at 508. For example, the communication link between the BS 502 and the UE 504 may include a path that reflects off an object in the environment, such that the portion beyond the reflection point is not within the direct LOS of the BS 502, as shown in FIG. 4. The BS 502 may configure the UE 504 to perform radar sensing over a set of beams to detect and predict the potential beam blockage in the future within a given time duration, at 510. This set of beams is associated with the N-LOS portion of the communication link from the BS 502, which is in the LOS portion of the communication link from the UE 504, thereby requiring UE assistance on radar sensing of the potential blockage. To enable the UE-based radar sensing of beam blockage, the BS 502 may configure JCS-RS resources and a JCS measurement report to the UE 502 via RRC signaling or a DCI/MAC CE activation command, at 512 and 514, respectively, similar to the above-described enhanced Rx beam refinement in FIG. 3. The UE 504 may perform radar sensing over a set of indicated beams, at 516, and may predict the future blockage of each beam indicated by the BS 502 in a given predefined time duration, at 518. The UE 504 may then perform JCS beam reporting by indicating, to the BS 502, the set of beams that are predicted to be blocked within the given pre-defined time duration, at 520. As a response, the BS 502 may proactively perform DL beam switching, at 522, to avoid predicted blockage of the beams within a pre-defined time duration. When the BS 502 detects that the link between the BS 502 and the UE 504 is a direct LOS, at 524, UE-based radar sensing may not be needed, and the BS 502 may instruct the UE 504 to stop radar sensing on the set of beams via DCI or RRC signaling or MAC CE, at 526.

The future beam blockage prediction, at 518, may be based on different prediction methods (e.g., a model-based method, such as a Kalman filter). A beam blockage prediction method may also be based on an ML-based beam predication signaling framework, such as, for example, an enhanced Rel-18 ML/artificial intelligence (AI) signaling framework, which includes the enhancement of Layer-1 (L1) signaling of the UE-side AI/ML model, signaling of data collection, and signaling of model inference, model monitoring.

For a UE-side AI/ML model of sensing assisted beam blockage prediction, L1 signaling may report information of AI/ML model inference to the network (e.g., BS or gNB). The information may include the predicted blocked beam(s) of N future time instance(s), which is based on the output of an AI/ML model inference. The information may also include confidence/probability information related to the output of the AI/ML model inference i.e., predicted blocked beams of N future time instance(s).

For data collection at the UE side for UE-side AI/ML model of sensing assisted beam blockage prediction, the UE may report to the network supported/preferred configurations of the uplink (UL) sensing RS transmissions. Data collection may be initiated/triggered by configuration from the network, or by a request from the UE for data collection. Signaling/configuration/measurement/report for data collection may be provided on sensing RSs, a configuration related to Set A and/or Set B, information on association/mapping of Set A and Set B, where Set A contains a set of predicted blocked DL beams and Set B contains a set of UL sensing RS beams.

For model inference for a UE-side AI/ML model of ISAC, an indication of the associated Set A may be provided from the network to the UE (e.g., association/mapping of beams within Set A and beams within Set B, where Set A contains a set of predicted blocked DL beams and Set B contains a set of UL sensing RS beams).

For a UE-side model, since there may be more than one Set A that the model supports, for a specific Set B, which the UE would measure as the input of the AI/ML model, the UE is informed of the associated Set A for output from the AI/ML model. For example, the specific indication can be the ID of Set A, which is included in the configuration for Set B

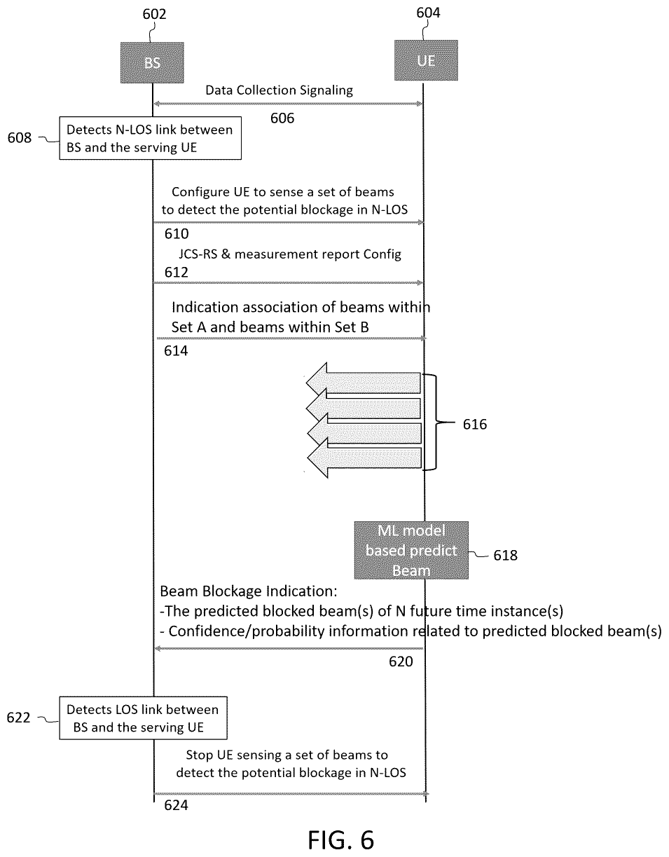

FIG. 6 is a diagram illustrating ML-based sensing assisted beam prediction, according to an embodiment.

A BS 602 and a UE 604 may exchange signaling to enable data collection for AI model training, AI model performance monitoring, and AI model selection or fallback, at 606. Specifically, the UE 604 may report a preferred UL sensing RS beam configuration to the BS 602. Data collection may be initiated by the configuration of the BS 602 or by UE request. The BS 602 informs the UE 604 of a configuration related to Set A and/or Set B and information on association/mapping of Set A and Set B, where Set A contains a set of predicted blocked DL beam(s) in future N time instances and Set B contains a set of UL sensing RS beams. The data collection may be running on a continuous basis in the background. There may be a need for an enhanced UE measurement/report, such as, for example, a new RSRP and/or SS/PBCH block resource indicator (SSBRI)/CRI report behavior (e.g., a larger number of RSRPs may be reported to generate labels and AI/ML inputs, or larger number of beam IDs may be reported as the AI/ML outputs, as opposed to a limited number of RSRP(s)).

Once the BS 602 detects a N-LOS link between the BS 602 and the UE 604, at 608, the BS 602 triggers UE-based beam prediction by configuring a set of sensing beams and measurement configurations, at 610 and 612, respectively. The BS 602 also indicates the association of beams within set A and beams within set B, at 614, where Set A contains set of predicted blocked DL beam(s) in future N time instances and Set B contains set of UL sensing RS beams. For a UE-side model, since there may be more than one Set A that the model supports, for a specific Set B that the UE 604 would measure as the input of the AI/ML model, the UE 604 is informed of the associated Set A for output from the AI/ML model. For example, a specific indication may be an ID of Set A included in a configuration for Set B.

The UE 604 sends configured UL sensing signals to sense the surrounding environment and measures the backscatter signals according to the BS configured measurement, at 616. The UE 604 uses the set of backscatter signals as input to the AL/ML model and performs AI/ML model inference, at 618. As output of the AI/ML model inference, the UE 604 obtains a set of predicted DL blockage beam(s) ID(s) for the future N time instances, as well as their corresponding probability information for each of the predicted DL blockage beam in the future N time instances. The UE 604 reports this information to the BS 602 via L1/L2 signaling (e.g., UCI or MAC CE) or RRC signaling, at 620.

When the BS 602 detects that the N-LOS link becomes a LOS link between the BS 602 and UE 604, at 622, the BS 602 may instruct the UE 604 to stop UE sensing assisted beam predication via L1 or L2 signaling (e.g., DCI or MAC CE) or RRC signaling, at 624.

AI/ML model performance may be monitored and assessed in a continuous manner, in order to decide whether to use a specific AI model for prediction or not use an AI method for prediction. In particular, the predicted blockage beam(s) in the future N time instances may be compared against a ground true blockage beam beam(s) in the future N time instances, such that the predication accuracy can be obtained. To enable this comparison, the BS may instruct the UE to measure the RSRP/RSRQ of all the possible DL beams in the set A to determine the blockage of each DL beam in the future N time instances, in parallel to the AI/ML-based predicted blockage DL beam(s) in the future N time instances based on an input of set B sensing beams. To enable this performance monitoring, the BS sweeps all DL beams from set A in the future N time instances to allow the UE to determine the actual blocked beams in the future N time instances. The UE may compute the percent of correctly predicted beam(s) of the N time instances based on the existing AI/ML model and report it to the BS via L1 UCI or RRC signaling. Finally, the BS may determine and indicate to the UE, via L1 DCI or L3 RRC signaling, whether to switch to another AI/ML model at the UE side, to keep an existing AI/ML model at the UE side, or to switch to a non-AI/ML-based prediction method at the UE side (e.g., Kalman filter). This decision may be based on the predication performance reported by the UE.

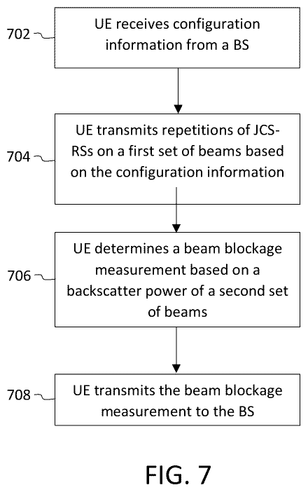

FIG. 7 is a flowchart illustrating a method for sensing-assisted beamforming, according to an embodiment. At 702, a UE receives configuration information a BS. The configuration information may include a first set of resources dedicated to JCS transmission and measurement, and a second set of resources dedicated to reporting JCS measurements. At 704, the UE transmits repetitions of JCS-RSs on a first set of beams based on the configuration information.

At 706, the UE determines a beam blockage measurement based on a backscatter power of a second set of beams received corresponding to the first set of beams. The beam blockage measurement may include a beam blockage rate, a number of blocked beams, a received signal strength on the second set of beams, and/or wideband or sub-band measurements. The beam blockage rate may cover beams in a pre-defined angular range starting from a right side of a serving receiver beam. The beam blockage rate may include a probability of beam blockage for the second set of beams in a pre-defined time period. The beam blockage measurement may be determined based on ML inference and may include a predicted blocked beam at a time instance and/or probability information for the predicted blocked beam.

At 708, the UE transmits the beam blockage measurement to the BS. When a DL beam between the BS and the UE includes a N-LOS link and the beam blockage measurement includes a predicted beam blockage, the BS may switch from the DL beam to another DL beam based on the predicted beam blockage. The BS may detect a LOS link between the BS and the UE and transmit instructions to cease determination of the beam blockage measurement.

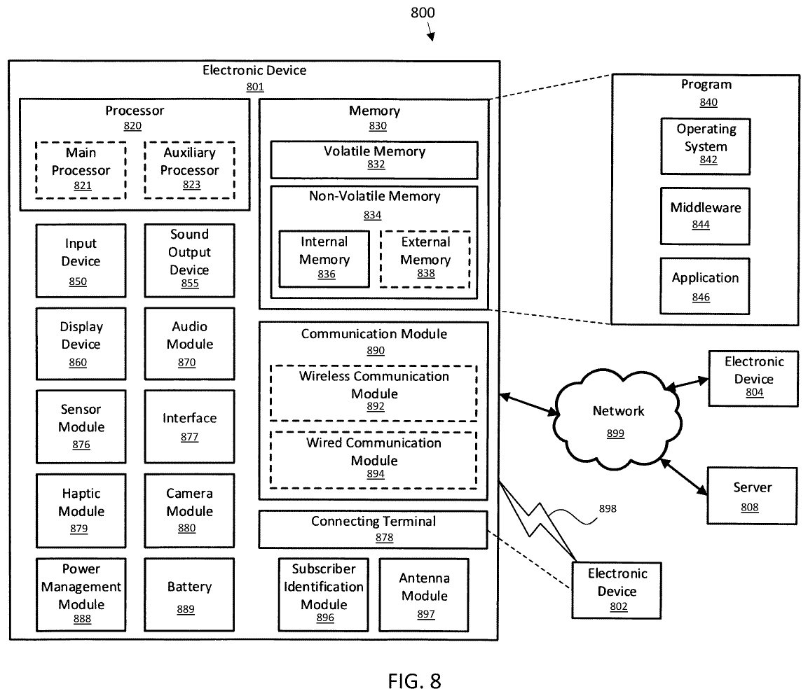

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, at a user equipment (UE), configuration information from a base station (BS);
transmitting, from the UE, repetitions of joint communication and sensing (JCS)-reference signals (RSs) on a first set of beams based on the configuration information;
determining, by the UE, a beam blockage prediction measurement for communication of a second set of beams received corresponding to the first set of beams; and
transmitting, by the UE, the beam blockage prediction measurement to the BS.

2. The method of claim 1, wherein the configuration information comprises a first set of resources dedicated to JCS transmission and measurement, and a second set of resources dedicated to reporting JCS measurements.

3. The method of claim 1, wherein the beam blockage prediction measurement comprises at least one of a beam blockage rate, a number of blocked beams, a received signal strength on the second set of beams, and wideband or sub-band measurements.

4. The method of claim 3, wherein the beam blockage rate covers beams in a pre-defined angular range starting from a right side of a serving receiver beam, and the beam blockage rate comprises a probability of beam blockage for the second set of beams in a pre-defined time period.

5. The method of claim 1, wherein a downlink (DL) beam between the BS and the UE comprises a non-line of sight (N-LOS) link, and the beam blockage prediction measurement comprises a predicted beam blockage.

6. The method of claim 5, wherein the BS switches from the DL beam to another DL beam based on the predicted beam blockage.

7. The method of claim 5, wherein the BS detects a line of sight (LOS) link between the BS and the UE, and further comprising:
ceasing, by the UE, determining of the beam blockage prediction measurement.

8. The method of claim 1, wherein the beam blockage prediction measurement is determined based on machine learning (ML) inference.

9. The method of claim 8, wherein receiving the configuration information comprises:
receiving information on an association between the first set of beams and a second set of beams, wherein the second set of beams comprises one or more predicted blocked DL beams.

10. The method of claim 8, wherein the beam blockage prediction measurement comprises at least one of a predicted blocked beam at a time instance and probability information for the predicted blocked beam.

11. A wireless system comprising:
a user equipment (UE) configured to:
receive configuration information from a base station (BS);
transmit repetitions of joint communication and sensing (JCS)-reference signals (RSs) on a first set of beams based on the configuration information;
determine a beam blockage prediction measurement for communication of a second set of beams received corresponding to the first set of beams; and
transmit the beam blockage prediction measurement to the BS; and
the BS configured to:
transmit the configuration information from the UE; and
receive the beam blockage prediction measurement from the UE.

12. The wireless system of claim 11, wherein a downlink (DL) beam between the BS and the UE comprises a non-line of sight (N-LOS) link, and the beam blockage prediction measurement comprises a predicted beam blockage.

13. The wireless system of claim 12, wherein the BS is further configured to switch from the DL beam to another DL beam based on the predicted beam blockage.

14. The wireless system of claim 12, wherein the BS is further configured to:
detect a line of sight (LOS) link between the BS and the UE; and
transmit, to the UE, an instruction to cease determination of the beam blockage prediction measurement.

15. A user equipment (UE) of a wireless system, the UE comprising:
a processor; and
a non-transitory computer readable storage medium storing instructions that, when executed, cause the processor to:
receive configuration information from a base station (BS);
transmit repetitions of joint communication and sensing (JCS)-reference signals (RSs) on a first set of beams based on the configuration information;
determine a beam blockage prediction measurement for communication of a second set of beams received corresponding to the first set of beams; and
transmit the beam blockage prediction measurement to the BS.

16. The UE of claim 15, wherein:
the configuration information comprises a first set of resources dedicated to JCS transmission and measurement, and a second set of resources dedicated to reporting JCS measurements; and
the beam blockage prediction measurement comprises at least one of a beam blockage rate, a number of blocked beams, a received signal strength on the second set of beams, and wideband or sub-band measurements.

17. The UE of claim 15, wherein a downlink (DL) beam between the BS and the UE comprises a non-line of sight (N-LOS) link, and the beam blockage prediction measurement comprises a predicted beam blockage.

18. The UE of claim 17, wherein the BS switches from the DL beam to another DL beam based on the predicted beam blockage.

19. The UE of claim 17, wherein the BS detects a line of sight (LOS) link between the BS and the UE, and further comprising:
ceasing, by the UE, determining of the beam blockage prediction measurement.

20. The UE of claim 15, wherein the beam blockage prediction measurement is determined based on machine learning (ML) inference.
